(19) United States
(12) Patent Application Publication
(10) Pub. No.: US 2010/0189000 A1
(43) Pub. Date: Jul. 29, 2010

(54) PREFIX INFORMATION CHECK DEVICE AND COMMUNICATION DEVICE

(75) Inventors: Jun Hirano, Kanagawa (JP); Chan Wah Ng, Singapore (SG); Mohana Dhamayanthi Jeyatharan, Singapore (SG); Chun Keong Benjamin Lim, Singapore (SG); Pek Yew Tan, Singapore (SG)

Correspondence Address: Dickinson Wright PLLC;James E. Ledbetter, Esq., International Square, 1875 Eye Street, N.W., Suite 1200, Washington, DC, 20006, US

(73) Assignee: Panasonic Corporation, Osaka (JP)

(21) Appl. No.: 12/665,238

(22) PCT Filed: Jun. 13, 2008
(86) PCT No.: PCT/JP2008/001518

§ 371 Date: Dec. 17, 2009

(30) Foreign Application Priority Data
Jun. 20, 2007 (JP) 2007-162016
May 30, 2008 (JP) 2008-142119

(51) Int. Cl. H04W 40/00; H04L 12/26

(52) U.S. Cl. 370/252; 370/328

(57) ABSTRACT

Disclosed is a technique to prevent the registration of false information that a mobile router is managing prefix information that is not actually managed. According to the technique, when a mobile network prefix is registered from an MR (mobile router 20) to a CN 30 (correspondent node), an HA (home agent) 10, for example, intervenes in signaling related to the registration to prevent the registration of false prefix information. For example, in process 150, the MR notifies the prefix information and the HA detects a test message 120 sent from the CN to the MR to check whether the prefix information used for the destination address is valid. If the prefix information is invalid, the packet is discarded.

### TECHNICAL FIELD

The present invention relates to a prefix information check device for checking prefix information specifying a network in a packet-switched data communication network such as an IP (Internet Protocol) network, and a communication device. Particularly, it relates to a prefix information check device for checking the prefix of a mobile network (mobile network prefix) owned by a mobile router having the mobile network, and a communication device.

### BACKGROUND ART

Many devices today communicate with each other using the Internet Protocol. In order to provide mobility support to mobile devices, the IETF (Internet Engineering Task Force) has defined the mobility support in IPv6 in Non-Patent Document 1 below. In Mobile IP, each mobile node has a permanent home domain. When the mobile node is attached to its home network, a primary global address known as a home-address (HoA) is assigned to the mobile node. When the mobile node is away from the home network, i.e., when it is attached to any other foreign network, a temporary global address known as a care-of-address (CoA) is usually assigned to the mobile node. The idea of mobility support is such that the mobile node is reachable at its home address even when it is attached to the other foreign network.

This idea is accomplished by introducing an entity called a home agent (HA) into the home network in Non-Patent Document 1. The mobile node registers its care-of address with the home agent using a binding update (BU) message. This allows the home agent to create a binding between the home address and the care-of address of the mobile node. The home agent has the functions of intercepting messages destined to the home address of the mobile node, and forwarding packets to the care-of address of the mobile node using packet encapsulation (i.e., by putting a packet as the payload of a new packet, which is also known as packet tunneling).

On the other hand, there is an idea of network mobility (NEMO) support, in which the concept of mobility support associated with individual hosts is extended to mobility support for networks including nodes. This network mobility support aims at providing a mechanism for making a node in a mobile network reachable at a primary global address even when the mobile network is connected to the Internet through any connection point.

Non-Patent Document 2 below proposes a solution to network mobility. Here, a mobile router specifies a network prefix used by a node in a mobile network when the mobile router sends a BU message to a home agent. This network prefix is specified using a special option known as a network prefix option inserted in the BU. This enables the home agent to build a routing table based on the prefix, and as a result, to forward a packet, to be sent to a destination having such a prefix, to a tunnel established between a care-of address of the mobile router and the home agent.

According to the above technique, the mobile network is reachable to the Internet regardless of the location of the connection point to which the mobile router is connected. However, since the packets sent from and received by the mobile network go through the tunnel between the mobile router and its home agent, routing is not fully optimized.

In order to cope with this condition, the NEMO basic specification may be so extended, for example, that the network prefix (mobile network prefix) of the mobile network is notified to a correspondent node (CN). The mobile network prefix is notified, for example, by adding the network prefix option capable of inserting the mobile network prefix to the BU message to be sent from the mobile router to the correspondent node.

However, only the addition of the network prefix option to the BU message causes a security problem. In mobile IPv6, when sending the BU message to the correspondent message to perform route optimization, a mobile node has to perform a return routability (RR) procedure beforehand to prove that it is the authorized owner of a home address and a care-of address described in the BU message. However, the return routability procedure cannot prove that it owns a prefix described in the network prefix option.

On the other hand, for example, Patent Document 1 below discloses an extended return routability procedure (XRRP). In this XRRP, a mobile network test init (MNTI) message is sent to a correspondent node, and the correspondent node returns a cryptographic token as a reply to this message. Then, a mobile router acquires this cryptographic token, creates and sends information indicating that the token of the BU message is extended based on this cryptographic token to prove that the mobile network prefix is owned by this mobile router.

Patent Document 2 below discloses a procedure called return routability for network prefix (RRNP). In this RRNP, a cryptographic token is sent from a correspondent node to an address belonging to a specific mobile network prefix. Then, a mobile router intercepts this cryptographic token and inserts the cryptographic token (or information obtained from the cryptographic token) into the BU message.

Patent Document 1: US Patent Application Publication No. 2006/120315

Patent Document 2: International Application Publication No. WO2006/006706

Patent Document 3: International Application Publication No. WO2006/118342

Patent Document 4: International Application Publication No. WO2008/023845

Non-Patent Document 1: Johnson, D. B., Perkins, C. F., and Arkko, J., “Mobility Support in IPv6,” Internet Engineering Task Force Request For Comments 3775, June 2004.

Non-Patent Document 2: Devarapalli, V., et. al., “NEMO Basic Support Protocol,” Internet Engineering Task Force Request For Comments 3963, January 2005.

However, although the method disclosed in Patent Document 1 or Patent Document 2 is to extend the return routability procedure of mobile IPv6 in order to validate the ownership of a network prefix, it does not always result in sufficient verification.

Here, the cryptographic token is sent to only an address (one or some addresses) selected from the network prefix the ownership of which is claimed by the mobile router. In other words, not all addresses belonging to the network prefix are verified.

For example, a mobile router assigned prefix P having a length of 64 bits can claim (declare) a correspondent node that the mobile router owns a prefix having a little shorter length (e.g., a length of 60 bits), i.e., a portion up to 60 bits in prefix P. At this time, although the correspondent node selects an address from the prefix (60 bit length), the ownership of which is claimed by the mobile router, to send a cryptographic token, the possibility that the address selected here contains prefix P (64 bit length) actually assigned to the mobile router is not zero.

When the correspondent node selects an address containing prefix P (64 bit length) actually assigned to the mobile router to send a cryptographic token, the mobile router can acquire the cryptographic token and register the prefix (60 bit length), enabling the mobile router to take over the prefix (60 bit length) having and address range larger than prefix P (64 bit length) actually owned by the mobile router.

On the other hand, according to a technique disclosed in Patent Document 3, the ownership of a mobile network prefix can be verified perfectly. However, this technique requires reliable devices (anchors), which can distribute certificates evidencing the ownership of prefixes, to be allocated to all domains where the mobile network exists, causing a problem that the system has to be extended significantly.

Further, in a case where a binding update without any care-of address in source addresses is sent to the home agent, there is a technique for causing the home agent to verify the care-of address (for example, a technique disclosed in Patent Document 4). However, even in such processing, the ownership of a prefix described in the network prefix option is not sufficiently proved.

### DISCLOSURE OF THE INVENTION

In view of the above-mentioned problems, it is an object of the present invention to prevent the registration of false information that a communication device (mobile router or mobile terminal) owning network prefix information is managing prefix information (network prefix or mobile network prefix) that is not actually managed.

In order to attain the above object, a prefix information check device of the present invention comprises:

packet specifying means for specifying a packet to be transmitted between a communication device assigned network prefix information and a correspondent node communicating with the communication device or a node connected to a network specified in the network prefix information; and

prefix information determining means for referring to the packet specified by the packet specifying means to determine whether a valid value is used for the network prefix information assigned to the communication device.

This structure enables prevention of registration of false information that a communication device (mobile router or mobile terminal) owning network prefix information is managing prefix information (network prefix or mobile network prefix) that is not actually managed.

In addition to the above structure, the prefix information check device of the present invention may also comprise packet discarding means for discarding the packet specified by the packet specifying means as a determination target when the prefix information checking means determines that an invalid value is used for the network prefix information assigned to the communication device.

This structure enables prevention of transmission of a packet related to registration of false information that a communication device owning network prefix information is managing prefix information that is not actually managed.

In addition to the above structure, the prefix information check device of the present invention may further comprise packet discard notifying means which, when the packet as the determination target has been discarded by the packet discarding means as a result of the determination that an invalid value is used for the network prefix information assigned to the communication device, notifies the communication device of that fact.

This structure enables a communication device owning network prefix information to clearly figure out that the packet has been discarded on the ground that invalid prefix information is used.

In addition to the above structure, the prefix information check device of the present invention may further comprise determination result notifying means for notifying the correspondent node of the result of determination made by the prefix information determining means.

This structure makes it possible to clearly notify a correspondent node that valid prefix information is used or invalid prefix information is used.

Further, in addition to the above structure, the prefix information check device of the present invention may be such that the packet specifying means specifies a packet exchanged when the network prefix information is notified from the communication device to the correspondent node.

According to this structure, when processing related to registration of prefix information is performed, registration of false information that a communication device owning network prefix information is managing prefix information that is not actually managed can be prevented.

Further, in addition to the above structure, the prefix information check device of the present invention may be such that the packet specifying means specifies the packet to be sent from the correspondent node to the communication device.

According to this structure, when processing related to registration of prefix information is performed, registration of false information that a communication device owning network prefix information is managing prefix information that is not actually managed can be prevented based on the packet to be sent from the correspondent node to the communication device owning network prefix information.

Further, in addition to the above structure, the prefix information check device of the present invention may be such that the prefix information determining means determines whether prefix information included in the packet specified by the packet specifying means is a valid value for the mobile network prefix information assigned to the communication device.

According to this structure, when processing related to registration of prefix information is performed, registration of false information that a communication device owning network prefix information is managing prefix information that is not actually managed can be prevented based on the packet to be sent from the correspondent node to the communication device owning network prefix information.

Further, in addition to the above structure, the prefix information check device of the present invention may be such that the packet specifying means extracts the prefix information included in a destination address of the packet, and the prefix information determining means refers to the extracted prefix information to make a determination.

According to this structure, when processing related to registration of prefix information is performed, registration of false information that a communication device owning network prefix information is managing prefix information that is not actually managed can be prevented based on the prefix information included in the destination address of the packet to be sent from the correspondent node to the communication device owning network prefix information.

Further, in addition to the above structure, the prefix information check device of the present invention may be such that the valid value for the network prefix information assigned to the communication device is so defined that the last digit is set to one, and the packet specifying means specifies a value of one in the last digit of the prefix information to extract the prefix information.

This structure enables extraction of prefix information from the destination address.

Further, in addition to the above structure, the prefix information check device of the present invention may be such that the packet specifying means extracts information indicative of the length of the prefix information and included in a destination address of the packet, and extracts the prefix information included in the destination address of the packet based on the length of the prefix information, and the prefix information determining means refers to the extracted prefix information to make a determination.

This structure enables extraction of prefix information from the destination address.

Further, in addition to the above structure, the prefix information check device of the present invention may be such that the packet specifying means specifies the packet including a specific bit pattern in a destination address of the packet.

This structure enables a packet including prefix information to be easily specified based on the destination address.

In addition to the above structure, the prefix information check device of the present invention may further comprise:

bit pattern setting means for defining the specific bit pattern; and

bit pattern notifying means for notifying the communication device or the correspondent node of the specific bit pattern so that the specific bit pattern will be set in the destination address of the packet.

This structure enables the prefix information check device to set the specific bit pattern dynamically.

Further, in addition to the above structure, the prefix information check device of the present invention may be such that the packet specifying means specifies the packet to be sent from the communication device to the correspondent node.

According to this structure, when processing related to registration of prefix information is performed, registration of false information that a communication device owning network prefix information is managing prefix information that is not actually managed can be prevented based on the packet to be sent from the correspondent node to the communication device owning network prefix information.

Further, in addition to the above structure, the prefix information check device of the present invention may be such that the prefix information determining means determines whether prefix information included in the packet specified by the packet specifying means is a valid value for the mobile network prefix information assigned to the communication device.

According to this structure, when processing related to registration of prefix information is performed, registration of false information that a communication device owning network prefix information is managing prefix information that is not actually managed can be prevented based on the packet to be sent from the correspondent node to the communication device owning network prefix information.

This structure enables extraction of prefix information from a destination address.

Further, in addition to the above structure, the prefix information check device of the present invention may be such that the communication device is a mobile router having a mobile network, and the network prefix information is a mobile network prefix specifying the mobile network.

This structure enables prevention of registration of false information that a mobile router is managing prefix information (mobile network prefix) that is not actually managed.

Further, in addition to the above structure, the prefix information check device of the present invention may be such that the communication device is a mobile terminal moving in a local mobility management domain for performing mobility support on a network basis, and the network prefix information is a network prefix uniquely assigned to the mobile terminal from the local mobility management domain.

This structure enables prevention of registration of false information that a mobile terminal assigned network prefix information due to network-based local mobility management is managing prefix information (network prefix) that is not actually managed.

Further, in addition to the above structure, the prefix information check device of the present invention may be such that the local mobility management domain is a foreign domain different from a home domain of the communication device, and the network prefix information is a care-of prefix to be registered in association with a home address of the communication device.

According to this structure, when a mobile terminal associates a prefix as a care-of prefix with a home address, the prefix being acquired from a foreign (not home) local mobility management domain, the authenticity of the prefix can be checked.

Further, in addition to the above structure, the prefix information check device of the present invention may be such that the local mobility management domain is a foreign domain different from a home domain of the communication device, and the network prefix information is a care-of prefix to be registered in association with a home prefix of the communication device.

According to this structure, when a mobile terminal associates a prefix as a care-of prefix with a home address, the prefix being acquired from a foreign (not home) local mobility management domain, the authenticity of the prefix can be checked.

Further, in addition to the above structure, the prefix information check device of the present invention may be such that the local mobility management domain is a home domain of the communication device, and the network prefix information is a home prefix assigned from the home domain.

According to this structure, when a mobile terminal uses, as a home prefix, a prefix acquired from a local mobility management domain as the home, the authenticity of the prefix can be checked.

Further, in addition to the above structure, the prefix information check device of the present invention may be such that the local mobility management domain is a home domain of the communication device, and the network prefix information include a first prefix used as a home prefix assigned from the home address and a second prefix used as a care-of prefix to be registered in association with the home prefix.

According to this structure, when a mobile terminal uses two prefixes acquired from a local mobility management domain as the home in association with each other as a home prefix and a care-of prefix, the authenticity of these prefixes can be checked.

Further, in addition to the above structure, the prefix information check device of the present invention may be such that the first prefix and the second prefix can be combined into a third prefix, and processing is performed on the third prefix to collectively check whether valid values are used for both the home prefix and the care-of prefix.

According to this structure, if prefixes having continuous values are set as a home prefix and a care-of prefix, for example, these prefixes can be handled collectively as one prefix upon checking the authenticity of prefixes, so that reduction in the number of messages, reduction in network traffic, reduction in the processing load on each node, etc. can be achieved.

In order to attain the above object, a communication device of the present invention comprises:

test message generating means for generating a test message to check whether a valid value is used for network prefix information when receiving a notification of the network prefix information assigned to a communication device from the communication device assigned the network prefix information; and

destination address setting means for generating an address including the notified network prefix information as an address prefix and information indicative of the length of the network prefix information to set the address as a destination address of the test message.

This structure enables extraction of prefix information from the destination address.

Further, in order to attain the above object, a communication device of the present invention comprises:

test message generating means for generating a test message to check whether a valid value is used for network prefix information when receiving a notification of the network prefix information assigned to a communication device from the communication device assigned the network prefix information; and

destination address setting means for generating an address including the notified network prefix information as an address prefix and a specific bit pattern indicative of the test message to set the address as a destination address of the test message.

This structure enables a packet including prefix information to be easily specified based on the destination address.

In addition to the above structure, the communication device of the present invention may also comprise:

bit pattern receiving means for receiving a notification of the specific bit pattern usable to indicate the test message; and

bit pattern authenticity checking means for checking the authenticity of the specific bit pattern received at the bit pattern receiving means.

This structure makes it possible to check whether the specific bit pattern notified for use in the test message is valid.

Further, in order to attain the above object, a communication device of the present invention is such that a valid value for network prefix information assigned to a communication device assigned the network prefix information is so defined that the last digit is set to one, and when a notification of the network prefix information assigned to the communication device is received from the communication device, it is checked that the value in the last digit of the network prefix information is one.

This structure can identify whether the prefix information is prefix information assigned to a network actually owned by the communication device owning network prefix information.

Further, in order to attain the above object, a communication device of the present invention is such that

a valid value for network prefix information assigned to a communication device assigned the network prefix information is so defined that the last digit is set to one, the communication device comprising;

test message generating means for generating a test message to check whether the valid value is used for network prefix information when a notification of the network prefix information assigned to the communication device is received from the communication device; and

destination address setting means for generating an address including the notified network prefix information as an address prefix and with a bit string following the address prefix set all to zero to set the address as a destination address of the test message.

This structure enables extraction of prefix information from the destination address.

Further, in order to attain the above object, a communication device of the present invention is such that

a valid value for network prefix information assigned to a communication device assigned the network prefix information is so defined that the last digit is set to one, the communication device comprising:

test message generating means for generating a test message to check whether the valid value is used for network prefix information when a notification of the network prefix information assigned to the communication device is received from the communication device; and

destination address setting means for generating an address including the notified network prefix information as an address prefix and with its tail bit set to one and the remaining bit string set all to zero to set the address as a destination address of the test message.

This structure enables extraction of prefix information from the destination address while avoiding overlap with a router anycast address.

The present invention has the above-mentioned structures, and the advantage of preventing the registration of false information that a communication device owning network prefix information is managing prefix information that is not actually managed.

### BRIEF DESCRIPTION OF THE DRAWINGS

FIG. 1 It is a sequence chart showing an example of typical route optimization signaling processing performed between a mobile router and a correspondent node according to an embodiment of the present invention.

FIG. 2 It is a flowchart showing a first example of algorithm executed by a home agent (prefix information check device) according to the embodiment of the present invention.

FIG. 3A It is a diagram showing a first example of destination address used in the embodiment of the present invention.

FIG. 3B It is a diagram showing a second example of destination address used in the embodiment of the present invention.

FIG. 4 It is a flowchart showing a second example of algorithm executed by the home agent (prefix information check device) according to the embodiment of the present invention.

FIG. 5 It is a flowchart showing a third example of algorithm executed by the home agent (prefix information check device) according to the embodiment of the present invention.

FIG. 6 It is a sequence chart showing an example of processing when a special bit pattern to be inserted by the home agent into a test packet is dynamically set according to the embodiment of the present invention.

FIG. 7 It is a flowchart showing a fourth example of algorithm executed by the home agent (prefix information check device) according to the embodiment of the present invention.

FIG. 8 It is a diagram showing a third example of destination address used in the embodiment of the present invention.

FIG. 9 It is a diagram showing an example of functional architecture of the home agent according to the embodiment of the present invention.

FIG. 10 It is a network configuration diagram showing an example of application to local mobility management according to the embodiment of the present invention.

FIG. 11 It is a sequence chart showing an example of processing when a mobile node sends the home agent a binding update including a care-of prefix according to the embodiment of the present invention.

FIG. 12 It is a sequence chart showing an example of processing when the mobile node sends a correspondent node a binding update including a care-of prefix according to the embodiment of the present invention.

FIG. 13 It is a network configuration diagram showing another example of application to local mobility management according to the embodiment of the present invention.

FIG. 14 It is a network configuration diagram showing still another example of application to local mobility management according to the embodiment of the present invention.

FIG. 15 It is a network configuration diagram showing an example when the mobile node performs handover in a cellular network according to the embodiment of the present invention.

### BEST MODE FOR CARRYING OUT THE INVENTION

An embodiment of the present invention will be described below with reference to the drawings.

According to the present invention, a home agent (or any node in a home domain) can intervene in signaling processing in exchanging prefix information between a mobile router registered with the home agent and a correspondent node communicating with this mobile router (or a mobile network node in a mobile network managed by the mobile router).

The intervention of this home agent ensures that the correspondent node can acquire valid prefix information, so that the correspondent node can avoid false recognition that the mobile router is managing prefix information (mobile network prefix) that is not actually managed.

There are several kinds of operations of causing the home agent to intervene in signaling (i.e., operations for attaining the object of the present invention), and the following describes basic example operations. It should be clear that techniques that can be contemplated from these example operations are also within the scope of the present invention. Further, prefix information in the specification includes an actual bit pattern that forms an address prefix and a length of the bit pattern (also called a prefix length). However, it should be clear that the present invention is not limited thereto.

According to the basic operation of the present invention, the home agent can carefully examine, in a prefix information determining section, a signaling packet exchanged between the mobile router and the correspondent node (i.e., a packet specified by a packet specifying section and transmitted between the mobile router or a mobile node under the control of the mobile router and the correspondent node). Suppose that information that induces the correspondent node to assume as if the mobile router was managing a prefix that was not actually managed (e.g., mobile network prefix information determined to use an invalid value is contained in the signaling packet. In this case, if the correspondent node falsely recognizes that this signaling packet is to be sent, a packet discarding section of the home agent will discard this signaling packet.

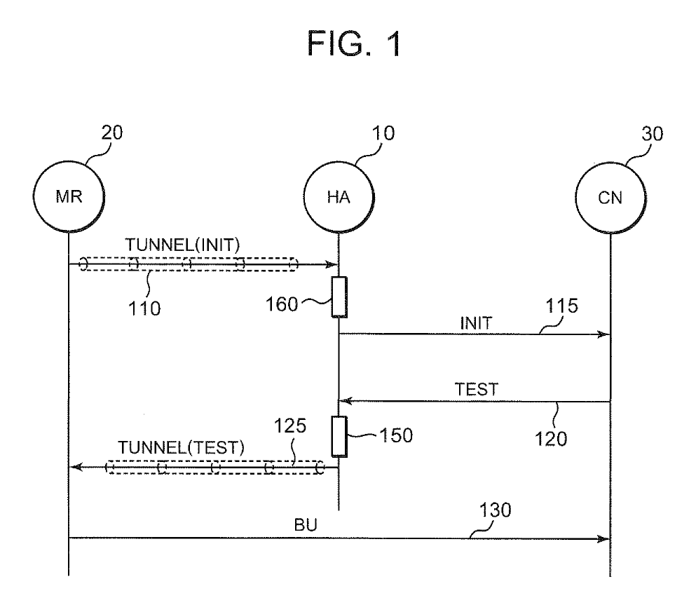

FIG. 1 is a sequence chart showing signaling exchanged between the mobile router and the correspondent node in the embodiment of the present invention.

Shown in FIG. 1 is an exemplary sequence chart of signaling between a mobile router (MR) 20 and a correspondent node (CN) 30, which is performed to register, with the CN 30, a binding indicating that the MR 20 is managing a certain mobile network prefix.

Note that processing typically used for route optimization is shown in FIG. 1. The route optimization is achieved by this processing. When the CN 30 sends a packet to an address belonging to this mobile network prefix, the packet can be forwarded directly to the current location of the MR 20. In route-optimized packet forwarding, the packet is encapsulated, for example, but any other technique may be used to forward the route optimized packet. Further, for example, a care-of address (CoA) of the MR 20 can be used as the current location of the MR 20, but the current location is not limited thereto.

Normally, in such signaling processing, the MR 20 first sends a route optimization start message to the CN 30, and the CN 30 returns a response through a test message including a cryptographically generated token. Then, the MR 20 sends a binding update message including a cryptographic token (or information obtained from the cryptographic token such as hash) to complete the route optimization processing.

For example, in a Return Routability (RR) procedure, two Initiation (Init) messages, namely a Home Test Init (HoTI) message and a Care-of Test Init (CoTI) message, are sent. Then, in response to these messages, two responses, namely a Home Test (HoT) message and a Care-of Test (CoT) message, are provided.

Further, in RRNP (see Patent Document 2), prefix information on the mobile network is notified through the HoTI message, and a recipient returns a response through a Network Prefix Test (NPT) message. This NPT message is forwarded via the home agent.

In XRRP (see Patent Document 1), prefix information on the mobile network is sent through a Mobile Network Node Test Init (MNNTI) message forwarded via the home agent, and the recipient returns a response through a Mobile Network Node Test (MNNT) message.

FIG. 1 shows a typical message sequence using only an Init (Initiation) message 115 and a test message 120. Note that the Init message 115 represents the HoTI message in RRNP, the MNNTI message in XRRP, or any test initiation message used in any other similar signaling processing. The test message 120 represents the NPT message in RRNP, the MNNT message in XRRP, or any test response message used in any other similar signaling processing. Several other messages, which are typically present in signaling processing, are omitted from FIG. 1 for simplicity.

In the typical message sequence shown in FIG. 1, the MR 20 first tunnels the init message to a home agent (HA) 10 via a tunnel packet 110. Then, the HA 10 sends an inner packet (actual init message 115) to the CN 30. The init message 115 includes information on the mobile network prefix the management of which is claimed by the MR 20.

On the other hand, the CN 30 returns a response through the test message 120. This test message 120 is intercepted by the HA 10, encapsulated in a tunnel packet 125, and forwarded to the MR 20. Then, the MR 20 sends a BU message 130 to the CN 30 to complete notification of the prefix information.

The BU message 130 includes prefix information to be associated by the CN 30 with the actual location of the MR 20. In other words, subsequent packets to be sent from the CN 30 to any destination present in the prefix are forwarded to the actual location (e.g., the care-of address of the MR 20) instead of being forwarded using a normal routing mechanism.

In addition, any cryptographic token to be inserted into the BU message 130 may be included in the test message 120 so that the CN 30 can verify that the MR 20 received the test message successfully.

In FIG. 1, there are two opportunities for the home agent (HA) 10 to intervene between the MR 20 and the CN 30 in order to check whether prefix information exchanged therebetween is valid. These opportunities are indicated by process 150 and process 160 in FIG. 1.

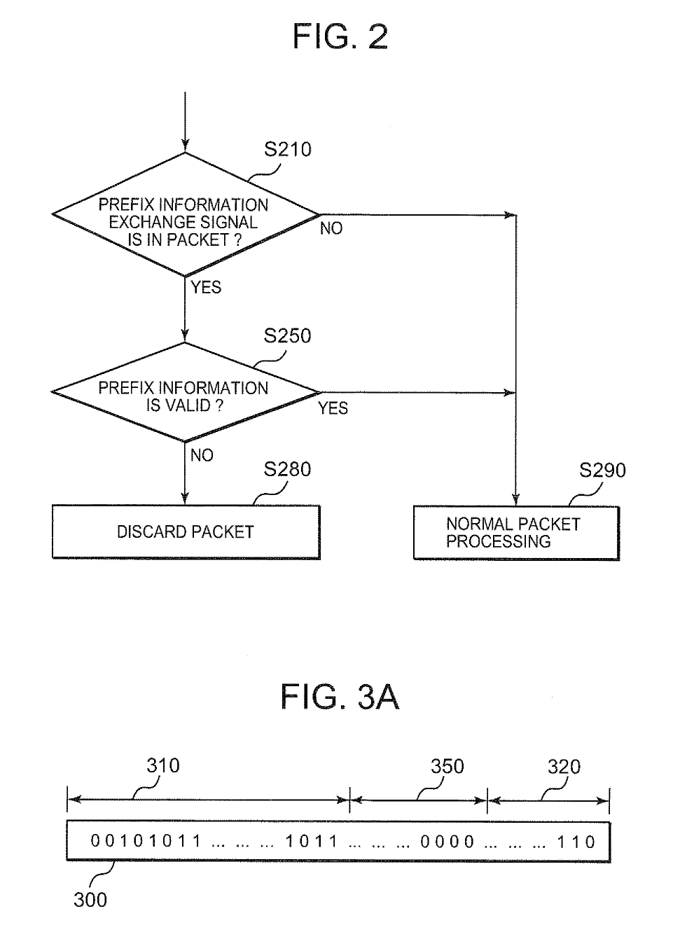

In the preferred embodiment of the present invention, the HA 10 uses an algorithm shown in FIG. 2 to be able to check, in either or both of these processes (processes 150 and 160 in FIG. 1), whether valid prefix information is sent to the CN 30.

First, in step S210, the HA 10 checks (init message, test message, or the like) whether a packet to be forwarded includes a signal for exchanging prefix information (prefix information exchange signal).

If such a signal is not included in the packet, the packet is processed normally in step S290 (e.g., the packet is sent according to normal IP packet routing rules). On the other hand, if the prefix information exchange signal is included in the packet, the HA 10 checks in step S250 whether prefix information included in the packet is valid.

If the prefix information is valid, normal packet processing (normal packet forwarding processing) is performed on the packet in step S290. On the other hand, if the prefix information is invalid, the packet is discarded in step S280.

Using the algorithm shown in FIG. 2, the HA 10 can discard the packet including invalid prefix information to stop the completion of the prefix information exchange procedure as shown in FIG. 1.

This can prevent the CN 30 from assuming mistakenly that the MR 20 is managing a mobile network prefix that is not actually managed. Thus, the object of the present invention is attained according to the aforementioned preferred embodiment of the present invention.

When the home agent checks whether prefix information being sent is valid, it should not be considered that the validity of the prefix information is checked only by checking whether the prefix information being sent is identical to the mobile network prefix assigned to the mobile router. This is because the mobile router may be dividing the prefix assigned to itself into various different segments depending on various purposes of use. Therefore, the home agent needs to consider, as valid, prefix information included in the range of the mobile network prefix assigned to the mobile router.

As mentioned above, the HA 10 can perform the algorithm shown in FIG. 2 at the two opportunities of process 160 (upon forwarding the packet tunneled from the MR 20) or process 150 (before tunneling the packet to the MR 20).

The following describes various preferred operations when the algorithm is performed in each of the processes 150, 160 in the embodiment of the present invention. Although description will be made below of various preferred operations, these various preferred operations may be performed in combination, or prefix information may be checked in both of processes 150 and 160.

For example, during the preferred operations in the embodiment of the present invention, the home agent (HA) 10 can intervene in signaling in process 150. In other words, the home agent (HA) 10 checks a packet to be forwarded to the MR 20.

From this check, it is determined whether prefix information is included in the packet, and if prefix information is included, it is further checked whether the prefix information is valid or invalid. If the prefix information is invalid, the packet is discarded.

For example, in RRNP, the CN 30 needs to send the NPT message to a destination in the mobile network. The HA 10 checks whether this NPT message is valid and discards the NPT message if required (that is, if invalid prefix information is included).

In XRRP, the CN 30 needs to send the MNNT message. The HA 10 checks whether the MNNT message is valid, and discards the MNNT message if required (that is, if invalid prefix information is included).

However, the home agent is typically a router that processes many packets. In contrast, prefix information exchange messages are just a few among the packets the home agent has to send. Therefore, if the home agent checks all packets as to whether to include prefix information, the home agent will be overloaded with processing.

The following describes a method of reducing the load on the home agent in a preferred operation according to the embodiment of the present invention. In this operation according to the present invention, when packets are forwarded according to the normal procedure, the home agent discards a packet to be sent to such a specific destination address to make a sender (e.g., CN 30) assume that the mobile router owns a prefix that is not actually owned. For example, the home agent detects a packet to be sent to an address including invalid prefix information and discards the packet.

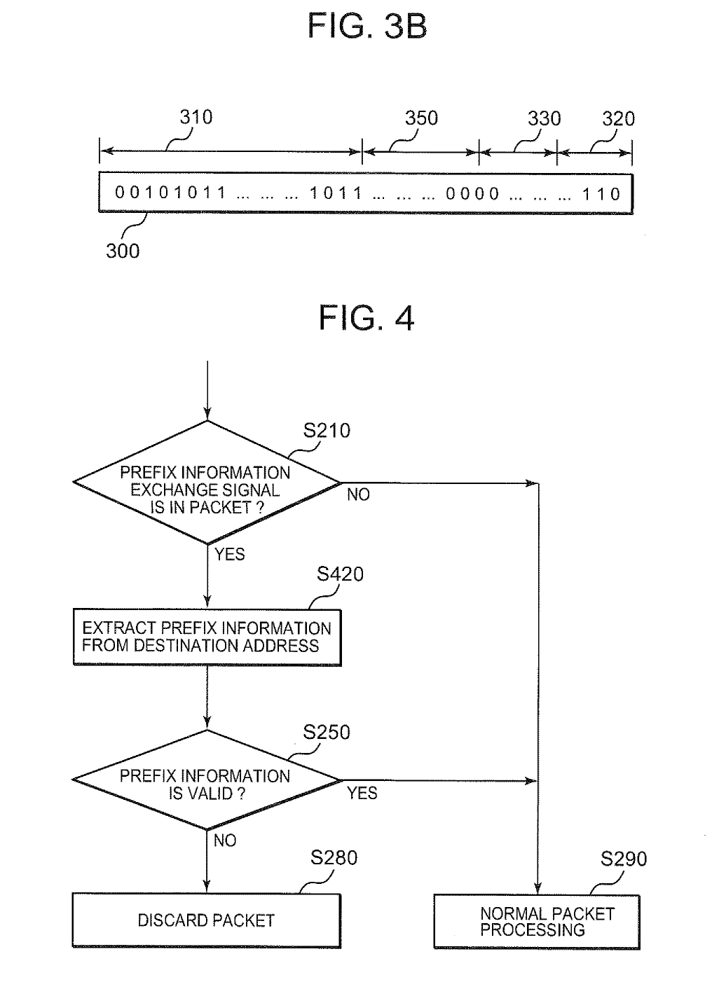

FIG. 3A shows an example of a specific address that could undergo this operation. A destination address 300 includes a prefix part 310, a length part 320, and a remaining part 350.

A prefix assumed by the sender to be owned by the mobile router is included in the prefix part 310. A value for the length of the prefix assumed by the sender to be owned by the mobile router is included in the length part 320. The remaining part 350 may take on any values. For example, it is desired that all values are set to zero so that the home agent can easily figure out this remaining part 350.

Since the address has a fixed length (e.g., 128 bits in IPv6), the size of the length part 320 is fixed, which may be known. For example, since the maximum value of the length part 320 is 127 in IPv6, the length part 320 may be 7 bits.

Thus, according to this preferred operation, when the CN 30 receives, from the MR 20, an init message claiming that the MR 20 is managing the prefix, the CN 30 sends a test message in such a manner that a test message generating section generates the test message, and a destination address setting section sets, as the destination address 300 of the test message, an address with P1 set in the prefix part 310 and L1 set in the length part 320.

In this case, the home agent (HA) 10 can use an algorithm shown in FIG. 4. A flowchart shown in FIG. 4 is a partial modification of the algorithm shown in FIG. 2, and the same steps in both algorithms are given the same reference numerals.

First, in step S210, the HA 10 checks (init message, test message, or the like) whether a packet to be forwarded includes a signal for exchanging prefix information (prefix information exchange signal).

If such a signal is not included in the packet, the packet is processed normally in step S290 (e.g., the packet is sent according to normal IP packet routing rules). On the other hand, if the prefix information exchange signal is included in the packet, the HA 10 extracts prefix information in step S420 from a destination address. This processing is performed by extracting the prefix part 310 and the length part 320.

Next, in step S250, the HA 10 checks whether the extracted prefix information is valid. If the extracted prefix information is valid, normal packet processing (normal packet forwarding processing) is performed on the packet in step S290. On the other hand, if the prefix information is invalid, the packet is discarded in step S280.

Using the algorithm shown in FIG. 4, the HA 10 can discard the test packet to be sent to the destination address including invalid prefix information to stop the completion of the prefix information exchange procedure as shown in FIG. 1.

This can prevent the CN 30 from assuming mistakenly that the MR 20 is managing a mobile network prefix that is not actually managed. Thus, the object of the present invention is attained according to the aforementioned preferred embodiment of the present invention.

The above-mentioned length part is an example of a case when the validity of prefix information is checked from the transmission address or the like. Information on this prefix length can be added as another option of the test message or may be sent as another message. Further, the prefix information may be notified as another message. In this case, it can be handled independently of the test message (on condition that it is determined until the completion of route optimization processing through the binding update message). Therefore, the MR can request the HA to notify the CN of valid prefix information. Alternatively, the CN can query the HA so that the HA will return valid prefix information as a response to the query.

Further, when the test message has been discard as a result of finding invalid prefix information, it is desired that a packet discard notifying section of the HA, which notifies that the packet has been discarded by the packet discarding section, should notify of that fact. This enables the MR to distinguish among cases where the CN has no route optimization capability, either of the init message or the test message has not arrived, and prefix information is invalid. As a result, the MR can not only avoid unnecessary processing such as to keep waiting for reception until timeout or to repeat transmission of the init message including invalid prefix information, but also prevent incorrect determination that the CN does not (cannot) perform route optimization, though it is capable of performing route optimization in practice.

In the above-mentioned preferred operation, the home agent has the advantage of eliminating the need to perform processing for extracting prefix information from the content of the test message, reducing the processing load on the home agent. However, the home agent still needs to carefully examine all received packets to be tunneled to the mobile router and check whether each packet is a test message. This processing places a heavy load on the home agent.

A method of further reducing the load on the home agent based on the following preferred operation will be described below.

In this preferred operation according to the present invention, the home agent checks whether the packet is a packet sent to a specific destination address, and only when a certain bit pattern is included in the destination address, it checks whether the packet is a test message.

FIG. 3B shows an example of a specific address that could undergo this operation. In FIG. 3B, the destination address 300 includes a bit pattern part 330 in addition to the prefix part 310 and the length part 320.

As mentioned above, a prefix assumed by the sender to be owned by the mobile router is included in the prefix part 310. A value for the length of the prefix assumed by the sender to be owned by the mobile router is included in the length part 320.

A specific bit pattern is included in the bit pattern part 330. The home agent can recognize this specific bit pattern to perform necessary checks. This specific bit pattern in the bit pattern part 330 allows the home agent to select a packet that is likely to be a test message.

The remaining part 350 may take on any values. For example, it is desired that all values be set to zero so that the home agent can easily figure out this remaining part 350.

Since the address has a fixed length (e.g., 128 bits in IPv6), the size of the length part 320 is fixed, which may be known. For example, since the maximum value of the length part 320 is 127 in IPv6, the length part 320 may be 7 bits.

The bit pattern part 330 may be of any size. The longer the bit pattern part 330, the smaller the maximum value of the acceptable prefix length. On the other hand, the shorter the bit pattern part 330, the higher the possibility that a normal packet (i.e., a packet other than the test message) sent to a destination address that happens to include the bit pattern is detected. This results in excess consumption of resources of the home agent that checks packets, and hence increase in processing load on the home agent. Therefore, it is desired that the bit pattern part 330 be set to a size as large as possible with respect to the size of the prefix length.

in this operation, when the CN 30 receives, from the MR 20, an init message claiming that the MR 20 is managing the prefix (prefix P1 and prefix length L1), a test message is sent in such a manner that the test message is generated in the test message generating section, and an address with P1 set in the prefix part 310, L1 set in the length part 320, and a known value indicating that this packet is a test message set in the bit pattern part 330 is set as the destination address 300 of the test message.

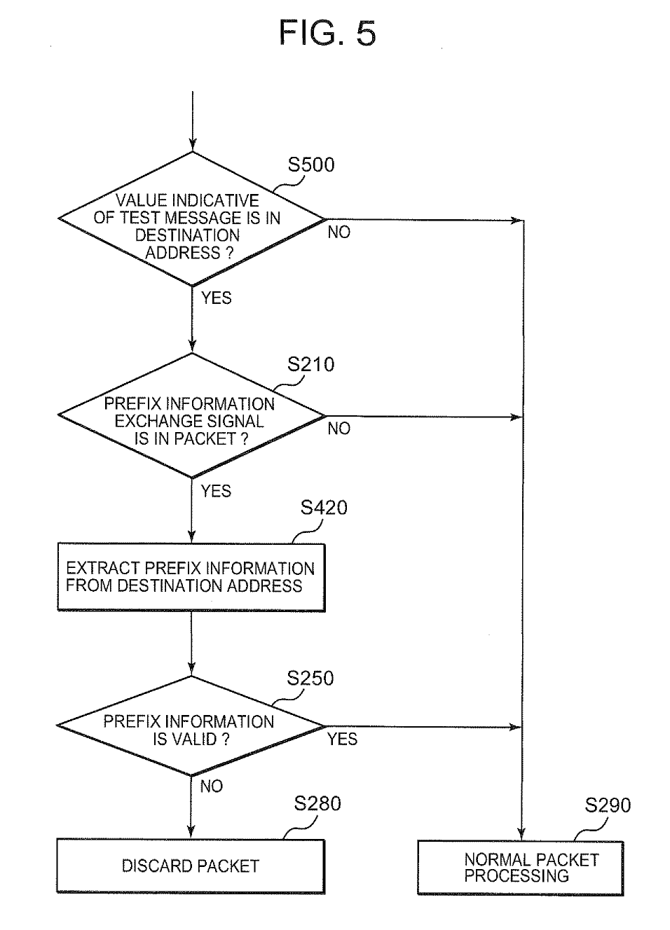

In this case, the home agent (HA) 10 can use an algorithm shown in FIG. 5. A flowchart shown in FIG. 5 is a partial modification of the algorithm shown in FIG. 4, and the same steps in both algorithms are given the same reference numerals.

First, in step S500, the HA 10 checks whether a known value indicative of the test message is included in the bit pattern part 330 of the destination address of the received packet.

If such a value is not included in the bit pattern part 330, the packet is processed normally in step S290 (e.g., the packet is sent according to normal IP packet routing rules). On the other hand, if the value indicative of the test message is included in the bit pattern part 330, the HA 10 extracts prefix information in step S420 from the destination address. This processing is performed by extracting the prefix part 310 and the length part 320.

Next, in step S250, the HA 10 checks whether the extracted prefix information is valid. If the extracted prefix information is valid, normal packet processing (normal packet forwarding processing) is performed on the packet in step S290. On the other hand, if the prefix information is invalid, the packet is discarded in step S280.

Using the algorithm shown in FIG. 5, the HA 10 can discard the test packet to be sent to the destination address including invalid prefix information to stop the completion of the prefix information exchange procedure as shown in FIG. 1.

This can prevent the CN 30 from assuming mistakenly that the MR 20 is managing a mobile network prefix that is not actually managed. Thus, the object of the present invention is attained according to the aforementioned preferred embodiment of the present invention.

In the above-mentioned preferred operation, the home agent checks whether the packet is the test message, and this has the advantage of eliminating the need to carefully examine all received packets, significantly reducing the processing load on the home agent.

In the above-mentioned preferred operation, a fixed and known value is used for the bit pattern part 330 to make the home agent know that the packet is the test message in order to reduce the processing load on the home agent. However, instead of the fixed or known value, the value included in the bit pattern part 330 may be dynamically set.

The following describes a preferred operation when a value included in the bit pattern part 330 is dynamically set.

In this preferred operation according to the present invention, the home agent itself can configure, in a bit pattern setting section thereof, the setting related to the bit pattern part 330, and notify the set bit pattern from a bit pattern notifying section thereof to the mobile router or the correspondent node. In other words, the home agent can set the value set in the bit pattern part 330 of the destination address. The home agent can also specify the position of the bit pattern part 330 in the destination address. The home agent can further specify the size of the bit pattern part 330. Thus, each home agent can determine the size of the bit pattern part 330 in consideration of the mobile network prefix used by the mobile router.

For example, in the case of a home network domain having a very long prefix part 310, the home agent can select (set) a small bit pattern part 330 to contain the long mobile network prefix.

Contrarily, in the case of a home network domain having a relatively short prefix part 310, the home agent can select (set) a large bit pattern part 330 to reduce the possibility of false recognition of a packet that is not the test message though the destination matches the bit pattern part 330.

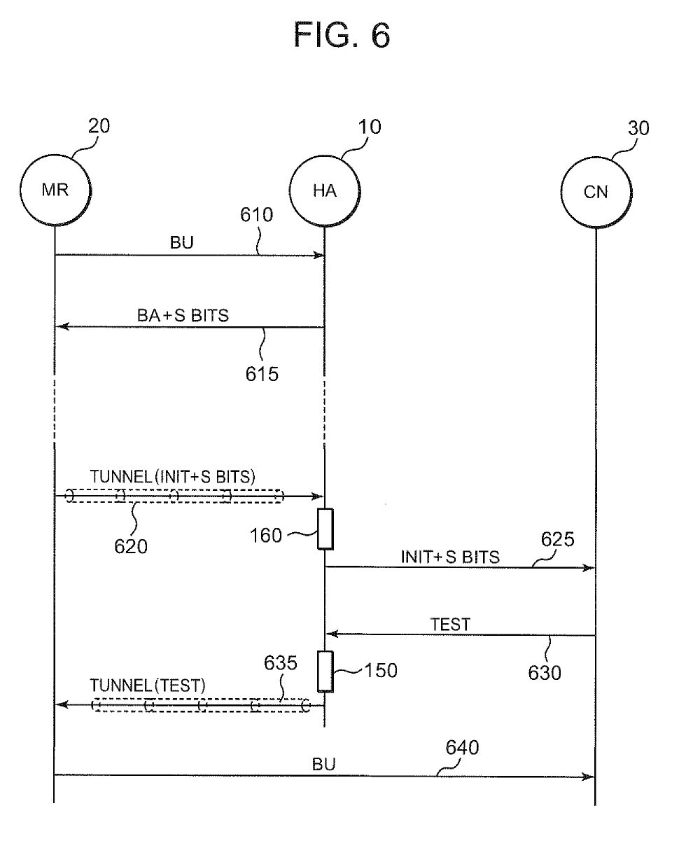

FIG. 6 is a message sequence chart showing a method of performing a preferred operation according to the preferred embodiment of the present invention. The mobile router (MR) 20 sends a BU message 610 to the home agent (HA) 10 to register a care-of address of the MR 20. After that, the HA 10 returns a response through a BA (Binding Acknowledgement) message 615.

The bit pattern notifying section of the HA 10 inserts, into this BA message 615, information on special bit pattern (S bit) used by the correspondent node. It is desired that this information include the value of the bit pattern part, the size of the bit pattern part, the position of the bit pattern in the address, etc.

When the MR 20 intends to register its mobile network prefix with the correspondent node (CN 30) in association with the care-of address, the MR 20 sends an init message to the CN 30. This init message is first encapsulated in a tunnel packet 620 to be sent to the HA 20.

Next, the HA 10 decapsulates the packet and forwards the init message 625 to the CN 30. The init message 625 includes information on the special bit pattern. This enables the CN 30 to send a test message 630 to a destination address with appropriate values set in the prefix part 310, the length part 320, and the bit pattern part 330.

At this time, the HA 10 can verify, in process 150, prefix information embedded in the destination address of the test message 630. If the prefix information is valid, the HA 10 can forward the test message to the MR 20 through a tunnel packet 635. Then, the MR 20 sends a BU message 640 to the CN 30, and ends the processing.

In another operation according to the present invention, information is used by the home agent or the correspondent node without being used by the mobile router. Therefore, the mobile router (MR) 20 does not need to know the information actually used in the bit pattern.

In this operation, the MR 20 does not insert the information on the bit pattern into the init message to be encapsulated in the tunnel packet 620. Instead, the MR 20 inserts several empty fields into the init message within the tunnel packet 620, so that the HA 10 enters bit pattern information in an inserted empty field when decapsulating the packet before transmission of an init message 625 to the CN 30. Thus, it is unnecessary for the bit pattern information to be transmitted to the MR 20 through the BA message 615, and hence for the MR 20 to store the bit pattern information.

Further, in order to reduce the processing load on the home agent, the MR 20 can insert any signal into the header of an outer packet of the tunnel packet 620 in the form of a router alert option or a destination option. This notifies the HA 10 of the need to enter bit pattern information in the inner packet encapsulated in the tunnel packet 620.

It is desired that information indicating that a bit pattern defined by the bit pattern setting section of the HA can be notified to the CN. For example, cryptographic signing indicating that at least the bit pattern is correct may be added as an option to the packet including the bit pattern indicated by the MR (so that the CN will check this cryptographic signing), cryptographic signing indicative of the authenticity of a bit pattern in the case of entering the bit pattern may also be added (so that the CN will check this cryptographic signing), or the MR may just make a request to notify a bit pattern to a specific CN so that the HA will notify the bit pattern to the CN. This enables the CN to check, in a bit pattern authenticity checking section, the authenticity of the notified bit pattern, preventing the MR from inserting a bit pattern, which is not intended by the HA, for the purpose of eluding a check from the HA.

In the above-mentioned preferred embodiment, the description has been made on the case where the home agent (HA) 10 makes a check in process 150 shown in FIG. 1. As mentioned above, the home agent can also use process 160 of the algorithm shown in FIG. 1.

The following describes an operation when a check is made in process 160. In this preferred operation according to the present invention, the home agent checks a packet tunneled from the mobile router. Then, in such a case that the delivery of this packet could cause the correspondent node to mistakenly believe that the mobile router is managing a prefix that is not actually managed, the packet is discarded.

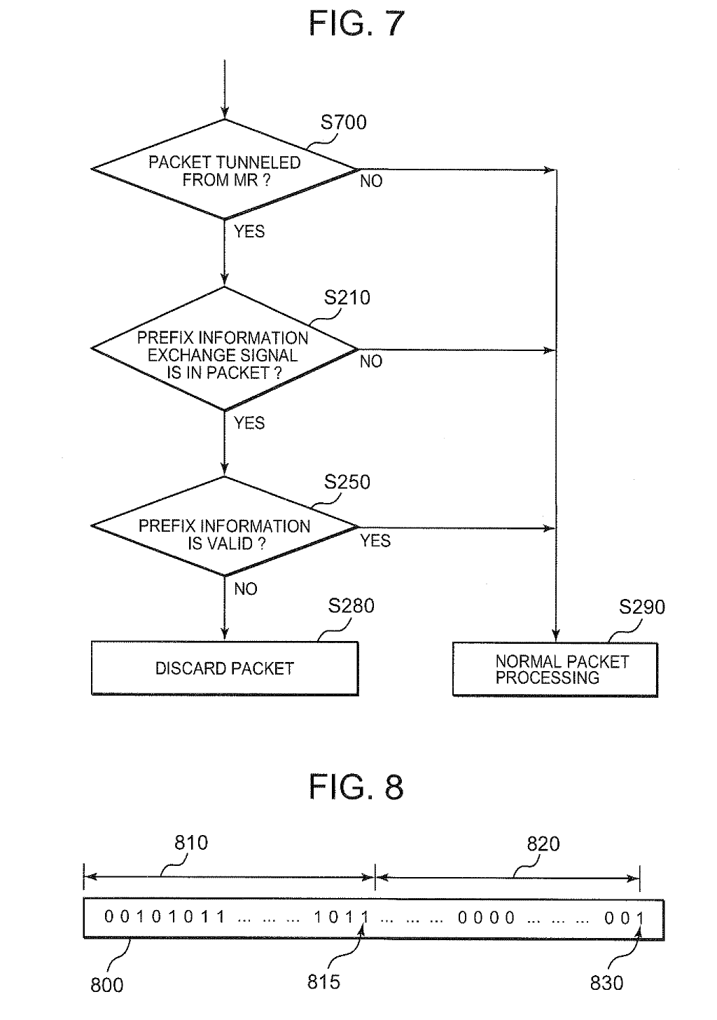

FIG. 7 shows a preferred algorithm for the home agent to perform processing on the packet tunneled from the MR according to the embodiment of the present invention.

A flowchart shown in FIG. 7 is a partial modification of the algorithm shown in FIG. 2, and the same steps in both algorithms are given the same reference numerals.

First, in step S700, the HA 10 checks whether the received packet is a packet tunneled from the mobile router. If the received packet is not the packet tunneled from the mobile router, the packet is processed normally in step S290 (e.g., the packet is sent according to normal IP packet routing rules).

On the other hand, if the received packet is the packet tunneled from the mobile router, the HA 10 checks in step S210 whether the packet to be forwarded includes a signal for exchanging prefix information (prefix information exchange signal).

If such a signal is not included in the packet, the packet is processed normally in step S290 (e.g., the packet is sent according to normal IP packet routing rules). On the other hand, if the prefix information exchange signal is included in the packet, the HA 10 checks in step S250 whether the extracted prefix information is valid.

If the extracted prefix information is valid, normal packet processing (normal packet forwarding processing) is performed on the packet in step S290. On the other hand, if the prefix information is invalid, the packet is discarded in step S280.

Using the algorithm shown in FIG. 7, the HA 10 can discard an init message to be sent to a destination address including invalid prefix information to stop the completion of the prefix information exchange procedure as shown in FIG. 1.

This can prevent the CN 30 from believing mistakenly that the MR 20 is managing a mobile network prefix that is not actually managed. Thus, the object of the present invention is attained according to the aforementioned preferred embodiment of the present invention.

In the above-mentioned preferred operation, the correspondent node does not need to be configured to send a test message to a specific destination address, and this has the advantage of eliminating the need to change the functions of the correspondent node.

For example, in the case of use of RRNP, prefix information on the mobile network is inserted into an HoTI message. The home agent carefully examines messages sent from the mobile router, and discards a message including invalid prefix information on the mobile network.

It is desired that the HA can notify the CN of information indicating that it has checked prefix information. For example, cryptographic signing indicating that at least the prefix information is correct may be added as an option to the packet (init message or the like) including the prefix information indicated by the MR (so that the CN will check this cryptographic signing), or the MR may just make a request to notify the prefix information to a specific CN so that the HA will notify the prefix information to the CN. This enables the CN to easily check whether this prefix information has been checked by the HA.

In the case of use of XRRP, prefix information on the mobile network is inserted into an MNNTI message. The home agent carefully examine messages from the mobile router, and discards a message including invalid prefix information on the mobile network.

When the HoTI message or MNNTI message is discarded, it is desired that the home agent send warning to the mobile router through an ICMP error message.

In the above-mentioned preferred operation, although the description has been made on the case where the home agent operates on signaling of prefix information exchanged between the mobile router and the correspondent node to ensure that valid prefix information is sent, the home agent can also actively start operating before the start of signaling to ensure that that valid prefix information is sent.

The following describes a preferred operation when the home agent ensures the transmission of valid prefix information before the start of signaling.

In this preferred operation according to the present invention, the home agent assigns a mobile network prefix to the mobile router in the home domain not only to enable the home agent or another correspondent node to easily verify whether it is correct prefix information, but also make it difficult for a malicious mobile router to claim the ownership of a mobile network prefix the mobile router does not actually own.

In a preferred example, the home agent always assigns the mobile router a mobile network prefix with its rightmost bit (the tail bit of the mobile network prefix) set to one. In this case, in order to verify an init message including prefix information of the mobile network prefix the ownership of which has been claimed by the mobile router, the correspondent node sends a test message to a destination address including this prefix information and with the remaining bits set all to zero.

The mobile network prefix with its rightmost bit set to one is always assigned to the mobile router. Therefore, even if the mobile router is to claim the ownership of a smaller prefix (i.e., a wider address range), since the claimed prefix and the destination address with the remaining bits set all to zero cannot contain the correct mobile network prefix value, the test message sent to this destination address is unreachable. As a result, signaling processing ends in failure, and the ownership of the smaller prefix the mobile router has attempted to claim ends in failure as well.

FIG. 8 shows a desired destination address 800 used when the correspondent node sends a test message in this operation.

A prefix (i.e., a prefix the ownership of which has been claimed by the mobile router through the init message) assumed by the sender to be owned by the mobile router is included in a prefix part 810. It is desired that the correspondent node check that the rightmost bit 815 of the prefix part 810 is one before transmission of the test message.

It is desired that a remaining part 820 be all set to zero, but the correspondent node may set the value of the tail bit 830 to one, for example, because the length of the prefix cannot be identical to that of the address. Although the address (all-zero address) in which subnetworks are all set to zero may be used for a special purpose (such as a subnet-router anycast address), a destination address without overlapping such a special address can be realized.

In other words, the correspondent node sends the test message in such a manner to generate a test message in the test message generating section and set, as the destination address 800 of the test message, an address in which a prefix seemed to be owned by the mobile router is set in the prefix part 810 and the remaining part 820 is all set to zero (or only the tail bit is set to one).

Here, it is important that a bit array following the prefix part 810 is set to zero. The wider the range of bits in the bit array set to zero (i.e., the larger the size of the remaining part 820), the narrower the range of the prefix part 810. This makes it more difficult for the mobile router to claim a prefix smaller than the prefix actually assigned. Thus, the object of the present invention is attained according to the aforementioned preferred embodiment of the present invention.

In this preferred operation, the home agent does not need to check the content of a forwarded packet, for example, and this has the advantage of not adding further processing load to the home agent. However, if the home domain consists mainly of the mobile network, network resources of the domain may go to waste (i.e., they become unusable). In other words, since all mobile network prefixes end with a bit set to one, prefixes with the last digit set to zero cannot be used as mobile network prefixes.

The following describes a method of assigning a prefix capable of reducing such prefix resource waste.

A prefix that ends with zero bit can be divided into two smaller prefixes. In other words, the prefix that ends with zero bit can be divided into prefixes having a prefix length of one bit longer, namely one the tail bit of which ends with one and the other the tail bit of which ends with zero. The prefix with its tail bit ending with one can be assigned as a mobile network prefix. On the other hand, the prefix with its tail bit ending with zero is further divided into prefixes having a prefix length of further one bit longer (namely one the tail bit of which ends with one and the other the tail bit of which ends with zero as well).

For example, it is assumed that the home agent has assigned a prefix having 64-bit length and the last bit of which is set to one. In this case, a prefix having 64-bit length and the last bit of which is set to zero can be divided into two prefixes having 65-bit length. Then, even if having 64-bit length with its last bit being zero, a prefix whose 65th bit is one can be assigned as a mobile network prefix having 65-bit length. On the other hand, a prefix having 65-bit length and the tail bit of which ends with zero can further be divided into two prefixes having 66-bit length, with half (a prefix whose 66th bit is one) assignable as a mobile network prefix as well.

For example, in the case of an IPv6 address of 128-bit length, this processing theoretically continues up to 127-bit prefix length, leaving only one useless address (unusable address). Note that a prefix having 126-bit prefix length and other prefixes having very long prefix lengths are rarely used in practice.

When a destination address is selected using the above-mentioned operations in combination, such a mobile network prefix that its last digit is set to one may be selected. For example, when the destination address shown in FIG. 3A is combined with the destination address shown in FIG. 8 as an example of such a combination, the tail bit of the mobile network prefix is always set to one in FIG. 3A. At this time, the correspondent node selects a destination address with the prefix (mobile network prefix whose tail bit is one) set in the prefix part, checks that the rightmost bit of the prefix part is set to one, sets the length part including the prefix length value to the rightmost bit of the address, and sets the remaining part to zero.

As another combination example, the destination address shown in FIG. 3B may be combined with the address shown in FIG. 8. At this time, the correspondent node selects a destination address with the prefix (mobile network prefix whose rightmost bit is one) set in the prefix part, checks that the rightmost bit of the prefix part is set to one, sets the length part including the prefix length value to the rightmost bit of the address, inserts a bit pattern immediately before the length part to set the bit pattern part, and sets the remaining part to zero.

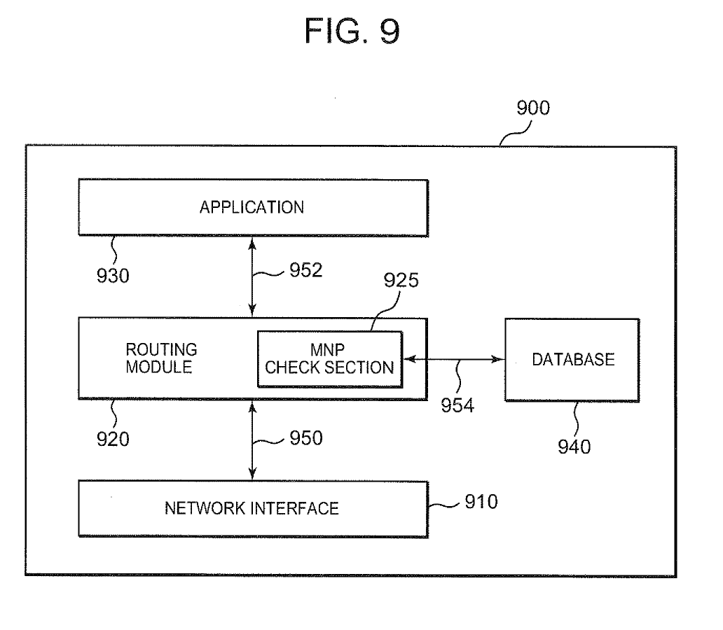

FIG. 9 shows an example of functional architecture of the home agent according to the embodiment of the present invention. The home agent according to the present invention has the function of ensuring that valid prefix information is sent.

The home agent shown in FIG. 9 includes one or plural network interfaces 910 for sending and receiving packets, a routing module 920 for deciding packet shipping and forwarding methods, a mobile network prefix (MNP) checking section 925 for checking a packet associated with a mobile network prefix, one or plural applications 930 including all protocols and programs that exist in layers higher than a routing layer, and a database 940 for storing configuration information on mobile routers and assignment of mobile network prefixes.

The network interface 910 is a functional block including all hardware and software necessary for this home agent to communicate with other nodes through any communication medium. Using a known term in the related art, the network interface 910 represents communication components of layer 1 (physical layer) and layer 2 (data link layer), firmware, drivers, and a communication protocol. Note that the home agent shown in FIG. 9 may have one or plural network interfaces 910.

The routing module 920 has the function of performing processing for deciding a packet shipping method. Using a known term in the related art, the routing module 920 represents implementation of a layer 3 (network layer) protocol such as IPv4 or IPv6. The routing module 920 can send and receive packets to and from an appropriate network interface 910 through a signal/data path 950.

An MNP checking section 925 having primary functions of the present invention exists in the routing module 920. It is desired that the MNP checking section 925 should perform an algorithm shown in any one of FIGS. 2, 4, 5, and 7, for example. Prior to the shipment of a packet, the routing module 920 passes the packet to the MNP checking section 925, and the MNP checking section 925 analyzes the packet based on the algorithm according to the present invention. As mentioned above, the MNP checking section 925 may discard the packet based on the packet analysis result. The primary functions of the prefix information check device provided by the present invention (i.e., functions each implemented by each component of the packet specifying section, the prefix determining section, the packet discarding section, the packet discard notifying section, a determination result notifying section for notifying the determination result of the prefix determining section, and the bit pattern setting section) are mainly performed by the MNP checking section 925.

The application 930 is a functional block including all protocols and programs that exist in layers higher than the routing layer of a communication protocol stack. This application 930 includes, for example, a transport layer protocol and a session layer protocol such as TCP (Transmission Control Protocol), STOP (Stream Control Transport Protocol), and UDP (User Datagram Protocol), or programs or software necessary to communicate with other nodes. Packets can be sent between the routing module 920 and the application 930 through a signal path 952.

The MNP checking section 925 needs to be accessible to information on assignment method for mobile network prefix in order to determine whether the mobile network prefix described in the packet is valid or not.

For example, such information is stored in the database 940, and the MNP checking section 925 can access the information stored in the database 940 through a signal path 954.

The mobile router may divide the assigned prefix into different segments for various purposes (including the purpose of use as a mobile network prefix). Therefore, in checking whether the sent prefix information is valid or not, the MNP checking section 925 needs to check not only whether the sent prefix information is identical to the mobile network prefix assigned by the mobile router, but also whether it falls within the range of the mobile network prefix to consider the prefix information within the range as valid prefix information.

The signal paths 950, 952, and 954 just represent logical connections, and they do not need to be physically wired. These signal paths represent calls of functions or subroutines, for example.

In FIG. 9, the database 940 is shown as a single unit, but it may be implemented using a physical memory buffer or stored as a file in a secondary memory. The database 940 can exist just as a subroutine, and in this case, actual information may be stored in a remote server (e.g., DHCP (Dynamic Host Configuration Protocol) server) physically different from the home agent so that only necessary information will be acquired therefrom.

While the present invention has been shown and described in this specification in terms of the most practical and preferred embodiment, it will be apparent to those skilled in the art that various changes can be made in the design of various components or the details of parameters without departing from the scope of the invention. For example, in the aforementioned embodiment, packets exchanged between the mobile router and the correspondent node are checked by the home agent, but they may be checked by other entities in the home domain. The other entities to make such checks include, for example, firewall introduced in the home domain (which has the function of scanning packets and discarding a packet that may adversely affect when it is sent).

The features of the mobile router of the present invention are applicable to a case where it moves in a network as a logical entity (to provide its corresponding state during moving to its subordinate mobile network nodes) as well as in the case of an actual mobile router. This corresponds to a case where context transfer or the like is performed to notify a subordinate mobile node not to change the network prefix even when the connection point has been changed.

The present invention is not necessarily limited to its application to the mobile router and the mobile network (i.e., to the verification of the ownership of a mobile network prefix). However, those skilled in the art will recognize that the present invention can be used in any situation for verification of the ownership of a network prefix.

For example, in the operation of a network-based local mobility management (NetLMM) protocol or the like, a prefix for network access can be assigned to a mobile node (or a mobile terminal or an UE (User Equipment)).

For example, it is assumed that a prefix unique to a mobile node is assigned when the mobile node is moving in a local mobility management domain (NetLMM domain). In this case, the mobile node may want to receive mobility support using this network prefix. The following describes a specific example in such a case.

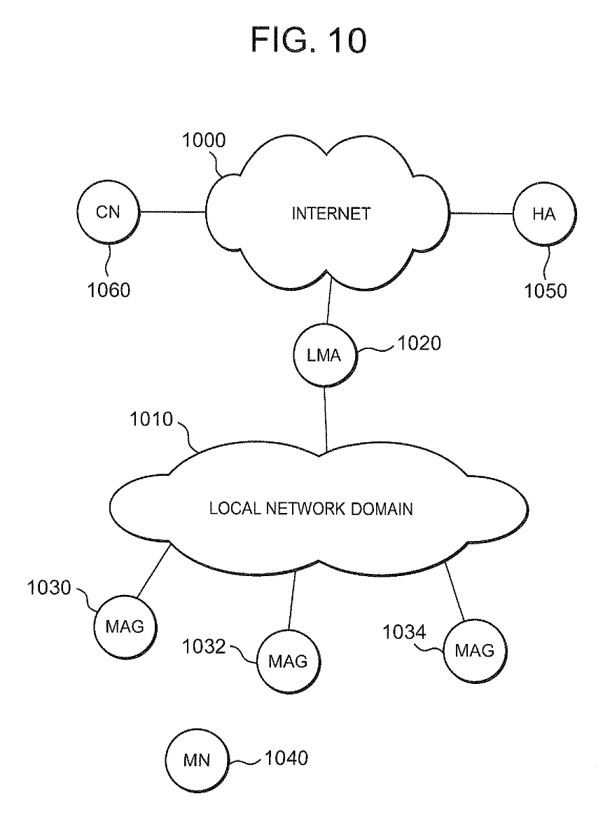

FIG. 10 shows an example of application to local mobility management according to the embodiment of the present invention. In FIG. 10, a local network domain 1010 is a local mobility management domain, which has a local mobility anchor (LMA) 1020, and mobile access gateways (MAG) 1030, 1032, and 1034.

A mobile node (MN) 1040 is moving in the local network domain 1010. The MN 1040 can communicate with a home agent (HA) 1050 or a correspondent node (CN) 1060 through a network, such as the Internet 1000, located outward when viewed from the LMA 1020 (which can be a network different from the Internet in the general sense, such as an operator-only network, though outside of the domain for local mobility support. Hereinafter referred to as the Internet 1000 as a generic term that includes such a case).

In the concept of network-based local mobility management, a prefix unique to the MN 1040 (e.g., P1) is assigned, for example. As long as the MN 1040 is moving in the local network domain 1010, this unique prefix P1 can reach the MN 1040 regardless of to which the MAG 1030, 1032, or 1034 the MN 1040 is connected.

The MN 1040 may want to use this prefix P1 as a care-of address used for a binding update to be sent to the HA 1050 or the CN 1060. Registration of prefix P1 using the binding update means that the MN 1040 associates, with the home address, all addresses within the range of the prefix P1 as care-of addresses.

This binding update includes the home address of the MN 1040, care-of prefix P1, and the prefix length of care-of prefix P1. A recipient that has received this binding update registers prefix P1 as a care-of prefix in association with the home address of the MN 1040. This registration enables the recipient that has received the binding update to send a packet to one of the addresses within the care-of prefix P1 instead of the home address in order to forward or send the packet to the home address of the MN 1040.

For example, the recipient of the binding update (i.e., the sender for sending the packet to the MN 1040. Hereinafter called the packet sender) determines which address should be selected from the prefix P1. The packet sender may select an address (packet shipping address) to the MN 1040 at random, or select an address based on some sort of filter rule (i.e., different flows are sent to respective care-of addresses within the range of the prefix P1. Alternatively, a specific address to be used by the MN 1040 (or a combination of a specific address and a specific flow) may be specified.

Further, the packet sender may send a string of packets (to be shipped to the MN 1040) to addresses within the range of the prefix P1 using some encryption function. For example, the packet sender may select an address used next from the prefix P1 using a pseudorandom sequence number. This is similar to a method using spread spectrum technology as a defense against denial-of-service (DoS) attacks. In this case, the MN 1040 ignores any received packet whose destination address does not comply with this pseudorandom sequence number.

As still another example, the packet sender may select an address within the range of the prefix P1 as a cryptographic hash value of the packet. This enables the MN 1040 to verify the authenticity of the packet.

On the other hand, if the packet sender accepts the care-of prefix in the binding update as being authentic without verification, a security problem can occur. For example, a malicious node can register the prefix P1 as the care-of prefix with the HA 1050 or the CN 1060 to make unnecessary data sent from the HA 1050 or the CN 1060 to the MN 1040 (actual owner of prefix P1) like DoS attacks.

In order to address such a security problem, the processing according to the present invention may be so extended that the ownership of a prefix can be verified.

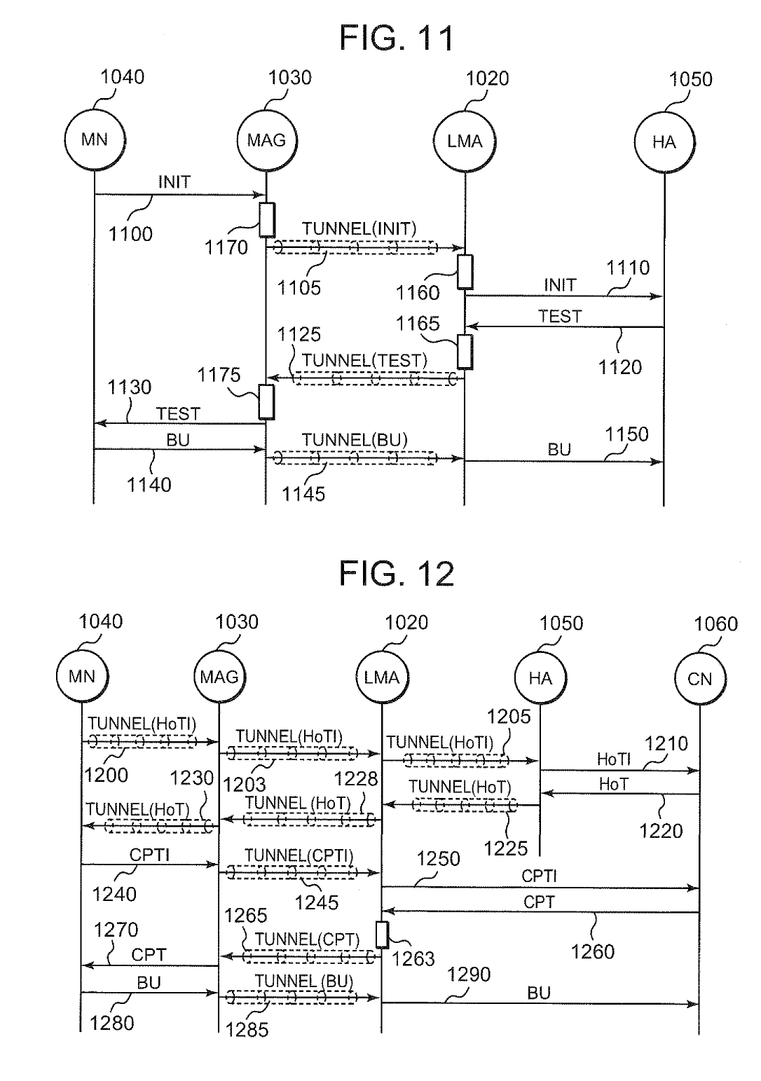

FIG. 11 and FIG. 12 show a preferred application example of the present invention to address such a security problem. FIG. 11 is a sequence chart showing processing when the mobile node sends the home agent a binding update including a care-of prefix according to the embodiment of the present invention.

In FIG. 11, the MN 1040 first sends an initiation (init) message 1100 to the 1050. This init message 1100 is encapsulated in a tunnel packet 1105 from the MAG 1030 to the LMA 1020 as necessary by a local mobility management protocol, and finally reaches the HA 1050 as an init message 1110. It is indicated in the init message 1110 that the MN 1040 owns prefix P1 having a prefix length (e.g., L1).

Then, the HA 1050 sends a test message 1120 to a test address within the range of the prefix P1. This test address can use any format (e.g., an address including prefix P1 and the length of the prefix P1) mentioned in the aforementioned embodiment. For example, an address having a value indicative of the length L1 of the prefix P1 in the least significant bit (LSB) can be used as the test address. Further, a known bit (or bit pattern) indicative of the test address may be included.

The LMA 1020 recognizes the known bit pattern in the test address of the test message 1120 to make a check indicated in process 1165. In this check, the LMA 1020 uses the algorithm shown in FIG. 4 or FIG. 5 to determine whether to forward or discard the test message 1120.

If prefix information in the test address is valid, the test message 1120 is tunneled and forwarded to the MAG 1030. Then, a tunneled test message 1125 is decapsulated at the MAG 1030, and finally reaches the mobile node MN 1040 as a test message 1130. A cryptographic token insertable by the MN 1040 into a binding update (BU) message 1140 may be included in this test message 1120.

This BU message 1140 is encapsulated in a tunnel packet 1145 from the MAG 1030 to the LMA 1020 as necessary by the local mobility management protocol, and finally reaches the HA 1050 as a BU message 1150. The HA 1050 can accept the binding to associate the care-of prefix P1 with the home address of the MN 1040 after checking the authenticity of the binding update.

In the example of operation shown in FIG. 11, the LMA 1020 checks and verifies the test message (i.e., process 1165), but the MAG 1030 may perform the same processing (i.e., process 1175) instead of the LMA 1020. If the MAG 1030 performs this processing, it has the advantage of reducing the processing load on the LMA 1020.

Unlike the above-mentioned case where the mobile network prefix is verified, the init message to be sent upon verification of the ownership of a prefix assigned in the local mobility management domain passes through the prefix information check device (MAG 1030 or LMA 1020). Therefore, in process 1170 or process 1160, for example, the MAG 1030 or the LMA 1020 may check the init message sent from the MN 1040.

In this case, if the prefix information in the test address is not valid, the LMA 1020 or the MAG 1030 can discard the init message. However, the LMA 1020 or the MAG 1030 cannot identify the init message without careful examination of the packet content (determination by address is impossible unlike the test message having a specific test address (or a test address including a specific bit pattern) as a destination). When the LMA 1020 or the MAG 1030 checks the init message, the processing load on the LMA 1020 or the MAG 1030 increases largely. It is therefore desired that the init message can be identified easily by acquiring a specific address or a bit pattern from the HA 1050.

FIG. 12 is a sequence chart showing a processing example when the mobile node sends the correspondent node a binding update including a care-of prefix according to the embodiment of the present invention.

The processing shown in FIG. 12 is a modification of the return routability procedure, where the CoTI message and the CoT message are replaced by a CPTI (care-of prefix test init) message and a CPT (care-of prefix test) message. The CPTI message corresponds to the init message according to the present invention, and is used to start processing for verifying the ownership of a prefix. On the other hand, the CPT message corresponds to the test message according to the present invention, and is used as a response to the init message to verify the ownership of the prefix.

In FIG. 12, the mobile node MN 1040 first sends an HoTI message 1200 and a CPTI message 1240 to the CN 1060 to start the processing as the modification of the return routability procedure according to the present invention. The HoTI message 1200 is sent after being encapsulated in a tunnel to the HA 1050. This HoTI message 1200 is encapsulated in a tunnel packet 1203 from the MAG 1030 to the LMA 1020 as necessary by the local mobility management protocol, and finally reaches the HA 1050 as a tunneled HoTI message (tunnel packet) 1205.

The HA 1050 decapsulates the tunnel packet 1205 and forwards an HoTI message 1210 to the CN 1060. When receiving the HoTI message 1210, the CN 1060 returns a response through an HoT message 1220 including a home keygen token created from the home address of the MN 1040.

The HoT message 1220 is first encapsulated in a tunnel packet 1225 at the HA 1050, and further encapsulated in a tunnel packet 1228 at the LMA 1020. The MAG 1030 decapsulates the outer tunnel and forwards the inner packet to the MN 1040, and the MN 1040 receives the tunnel packet including the HoT message from the HA 1050.

The CPTI message 1240 is encapsulated in a tunnel packet 1245 from the MAG 1030 to the LMA 1020 as necessary by the local mobility management protocol, and finally reaches the CN 1060 as a CPTI message 1250. The CPTI message 1250 indicates that the MN 1040 owns prefix P1 having a prefix length (e.g., L1).

The CN 1060 sends a CPT message 1260 to a test address within the range of the prefix P1. This test address can use any format (e.g., an address including prefix P1 and length L1 of the prefix P1) mentioned in the aforementioned embodiment. For example, an address having a value indicative of the length L1 of the prefix P1 in the least significant bit (LSB) can be used as the test address. Further, a known bit (or bit pattern) indicative of the test address may be included.

The LMA 1020 recognizes the known bit (or bit pattern) in the test address of the CPT message 1260 to make a check indicated in process 1263. In this check, the LMA 1020 uses the algorithm shown in FIG. 4 or FIG. 5 to determine whether to forward or discard the CPT message 1260.

If prefix information in the test address is valid, the CPT message 1260 is tunneled and forwarded to the MAG 1030. Then, a tunneled CPT message 1265 is decapsulated at the MAG 1030, and finally reaches the mobile node MN 1040 as a CPT message 1270. It is desired that a cryptographic token (care-of keygen token), like the home keygen token, obtained from the care-of prefix in the CPTI message 1250 be included in this CPT message 1260.

When receiving the HoT message 1230 and the CPT message 1270, the MN 1040 can use a home keygen token and a care-of address keygen token included in these messages to create a mobility management key to be used in a BU message 1280. This BU message 1280 is encapsulated in a tunnel packet 1285 from the MAG 1030 to the LMA 1020 as necessary by the local mobility management protocol, and finally reaches the CN 1060 as a BU message 1290.

The CN 1060 can accept the binding to associate the care-of prefix P1 with the home address of the MN 1040 after checking the authenticity of the binding update.

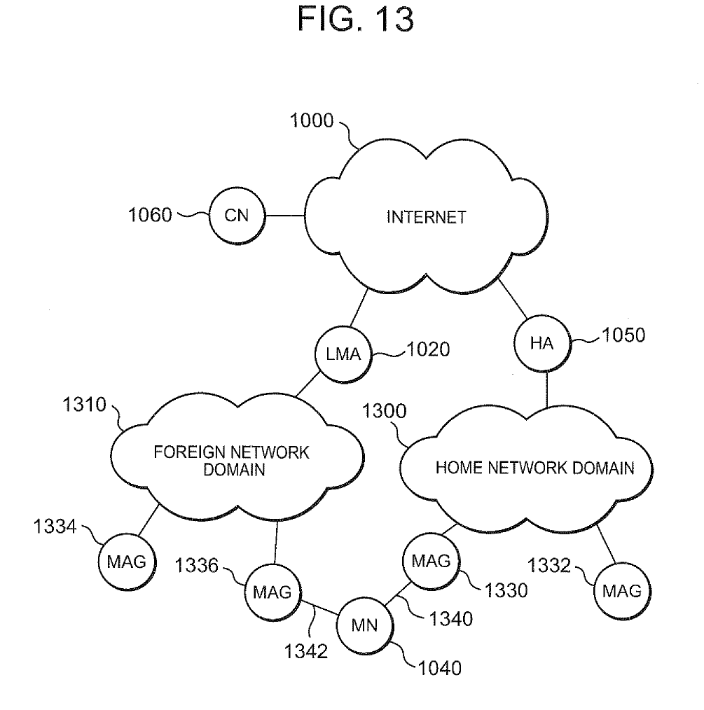

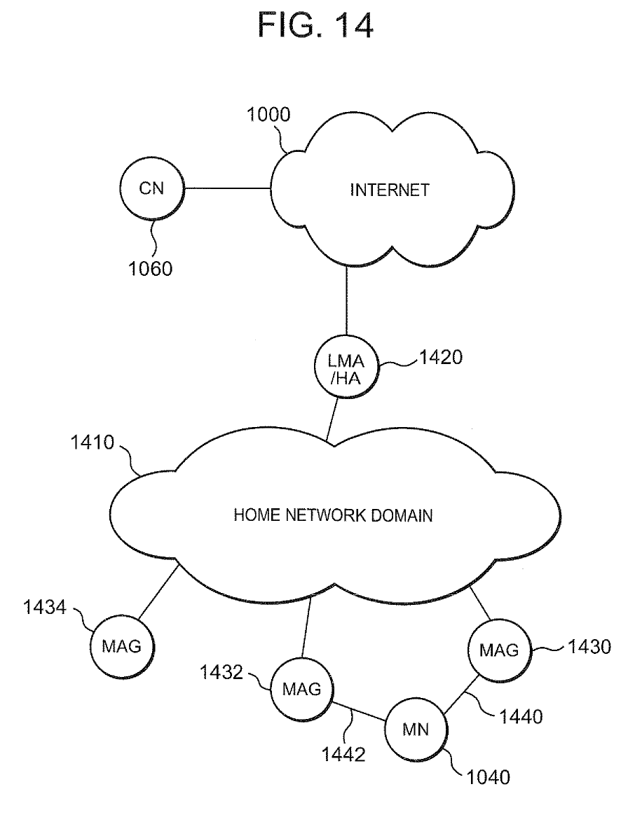

In FIGS. 10 to 12, such a scenario to associate a prefix with the home address is shown in order that the MN 1040 uses, as a care-of prefix, the prefix assigned from a foreign local mobility management domain. On the other hand, the home domain of the MN 1040 may be the local mobility management domain. In this case, a home prefix (home prefix uniquely assigned to the MN 1040) used by the MN 1040 alone may be used instead of the home address of the MN 1040. The following describes such a scenario with reference to FIG. 13 and FIG. 14.

FIG. 13 shows a network configuration showing another example of application to the local mobility management according to the embodiment of the present invention. In FIG. 13, a home network domain 1300 is a home network of the MN 1040, including the HA 1050 and MAGs 1330, 1332. On the other hand, a foreign network domain 1310 is a foreign network for the MN 1040, including the LMA 1020 and MAGs 1334, 1336.

The mobile node 1040 has two connections 1340, 1342 to two different local mobility management domains (the home network domain 1300 and the foreign network domain 1310), and can communicate with the CN 1060 through the Internet 1000. The connection 1340 is made to the MAG 1330 in the home network domain 1300, and the connection 1342 is made to the MAG 1336 in the foreign network domain 1310. The home network domain 1300 and the foreign network domain 1310 are also connected by the Internet 1000 so that the networks can communicate with each other through the Internet 1000.

In this case, the MN 1040 may want to register, with the HA 1050, a prefix (e.g., P2) obtained from the connection 1342 in association with the care-of prefix. In this case, the present invention can be so employed that the LMA 1020 can verify if the MN 1040 actually owns the prefix P2.

Further, a prefix (e.g., P1) may be assigned to the MN 1040 from the home network domain (local mobility management domain) 1300. In this case, any address obtained from the prefix P1 may be handled as the home address. Therefore, when the MN 1040 is to perform route optimization with the CN 1060, the MN 1040 may describe the home prefix P1 itself instead of a single home address obtained from the home prefix P1. Thus, the registration of the home prefix P1 itself enables an address within the range of the prefix P1 to be used as the home address when the MN 1040 communicates with the CN 1060.

To this end, the MN 1040 has only to replace the HoTI message to be sent in association with the home address by a home prefix test init (HPTI) message including a home prefix and a prefix length. When receiving the HPTI message, the CN 1060 returns a response through a home prefix test (HPT) message. A home agent (i.e., the HA 1050) of the MN 1040 uses the present invention to discard an HPT message including an HPT address including an invalid home prefix.

The MN 1040 can also register, with the CN 1060, a binding update to associate the prefix P2 assigned as a care-of prefix from the foreign network domain 1310 with the home prefix P1 assigned from the home domain 1200. As a result of this registration, the MN 1040 replaces the HOTI message by the HPTI message including the home prefix P1, and the CoTI message by the CPTI message including the care-of prefix P2 in the return routability procedure according to the present invention.

When receiving the HPTI message, the CN 1060 sends an HPT message to a specific test address according to the present invention. If a prefix indicated in the test address is invalid, the HA 1050 discards the HPT message, while if the prefix indicated in the test address is valid, the HA 1050 forwards the HPT message.

When receiving the CPTI message, the CN 1060 sends a CPT message to a specific test address according to the present invention. If a prefix indicated in the test address is invalid, the LMA 1020 discards the CPT message, while if the prefix indicated in the test address is valid, the LMA 1020 forwards the CPT message.

FIG. 14 shows a network configuration showing still another example of application to the local mobility management according to the embodiment of the present invention. FIG. 14 shows a case where the MN 1040 is connected to different MAGs 1430 and 1432, respectively, in a home network domain 1410.

In FIG. 14, the home network domain 1410 is a local mobility management domain, including an LMA/HA 1420 functioning not only as an LMA in the home network domain 1410 but also a home agent of the MN 1040, and MAGs 1430, 1432, and 1434. The LMA/HA 1420 is connected to the Internet 1000, and the MN 1040 can communicate with the CN 1060 through the Internet 1000.

The MN 1040 receives two different prefixes through respective connections 1440 and 1442 according to the operation of local mobility management. Here, as an example, it is assumed that prefix P1 is received through connection 1440 and prefix P2 is received through connection 1442. In this case, the MN 1040 can select one of the prefixes as a home prefix. Here, it is assumed that the MN 1040 selects the prefix P1 as the home prefix. The prefix P2 may be used as a care-of prefix, for example.

In such a case, the MN 1040 can adopt the same processing as the processing described above with reference to FIG. 13 to register, with the LMA/HA 1420, the prefix P2 as the care-of prefix in association with the prefix P1 as the home prefix. Since the prefix P1 and the prefix P2 are both assigned by the LMA/HA 1420, the LMA/HA 1420 does not need to verify the validity thereof.

Similarly, the MN 1040 can also adopt the same processing as the processing described above with reference to FIG. 13 to register, with the CN 1060, the prefix P2 as the care-of prefix in association with the prefix P1 as the home prefix. In the case of registration with the CN 1060, both the HPT message and the CPT message sent from the CN 1060 are verified by the LMA/HA 1420 to test the ownership of the prefix P1 and the prefix P2.

In a scenario shown in FIG. 14, the prefix P1 and the prefix P2 are located next to each other. Therefore, if they can be handled as a smaller prefix P0, the prefixes may be able to be verified collectively. For example, if the prefix P1 is 2201:ff00:1121:0200::/64 and the prefix P2 is 2201:ff00:1121:0201::/64, these prefixes can be handled as prefix P0 (2201:ff00:1121:0200::/63) in practice.

When it is verifiable that the MN 1040 owns the prefix P0, it is automatically indicated that the MN 1040 owns both the prefix P1 and the prefix P2. When the MN 1040 tries to register, with the CN 1060, the prefix P2 as the care-of prefix in association with the prefix P1 as the home prefix, the MN 1040 may declare the ownership of the prefixes separately for prefix P1 and prefix P2, respectively, or declare the ownership of the prefix P0 including the prefix P1 and the prefix P2. In other words, the MN 1040 may combine the CPTI message and the HPTI message to send a single home-and-care-of prefix test init (HCPTI) message declaring that the MN 1040 owns the prefix P0.

When receiving this HCPTI message, the CN 1060 returns a response according to the present invention through a home-and-care-of prefix test (HCPT) message having the test address as a destination address. If the prefix indicated in the test address is invalid, the HA 1420 discards this HCPT message, while if the prefix indicated in the test address is valid, the HA 1420 forwards the HCPT message.

The MN 1040 extracts a token from the HCPT message to generate, using this token, an authenticator (authentication information) in a BU message to be sent to the CN 1060. This BU message indicates the ownership of the home prefix P1 and the care-of prefix P2.

In addition to the case where the MN 1040 is connected to both the home network domain 1300 and the foreign network domain 1310 as in the example shown above in FIG. 13, the present invention is also applicable to a case where the MN 1040 performs handover (e.g., when switching over from the connection 1340 to the connection 1342). If the connection is simply switched over between different network domains, an operation corresponding to the connection status shown in FIG. 10 during connection to each network domain (especially during connection to the foreign network domain) has only to be performed. On the other hand, if there is an advanced roaming relationship between network domains before and after handover such as that between cellular network operators, prefix registration may enable efficient communication even if the connection between the MN 1040 and the network domain is made only at one point.

As such a case, for example, there is a case where a prefix assigned before handover can continue to be used in a network domain after handover based on the advanced roaming relationship between the network domains regardless of whether the network domains before and after handover are home or foreign (note that foreign to foreign transfer can occur). In such a case, if a prefix is newly acquired in the network domain after handover, since it means that the MN 1040 is assigned plural prefixes, registration (and verification) of a foreign network prefix as shown in the example of FIG. 13 can be made. Further, the home network prefix may be able to be registered with (and verified by) a device corresponding to the HA in a foreign network domain depending on the roaming relationship.

The same can be said of the example shown above with reference to FIG. 14. In other words, even if the number of connections of the MN 1040 is one (e.g., only the connection 1440), there is a case where plural prefixes are assigned from the home network domain 1410. For example, when different prefixes (to be associated with tunnels or the like in a local mobility domain) are assigned according to different connection requirements (necessary conditions for transmission parameters such as destination network, delay, etc.), since it means that the MN 1040 is assigned plural prefixes, registration (and verification) of a care-of prefix as shown in the example of FIG. 14 can be made.

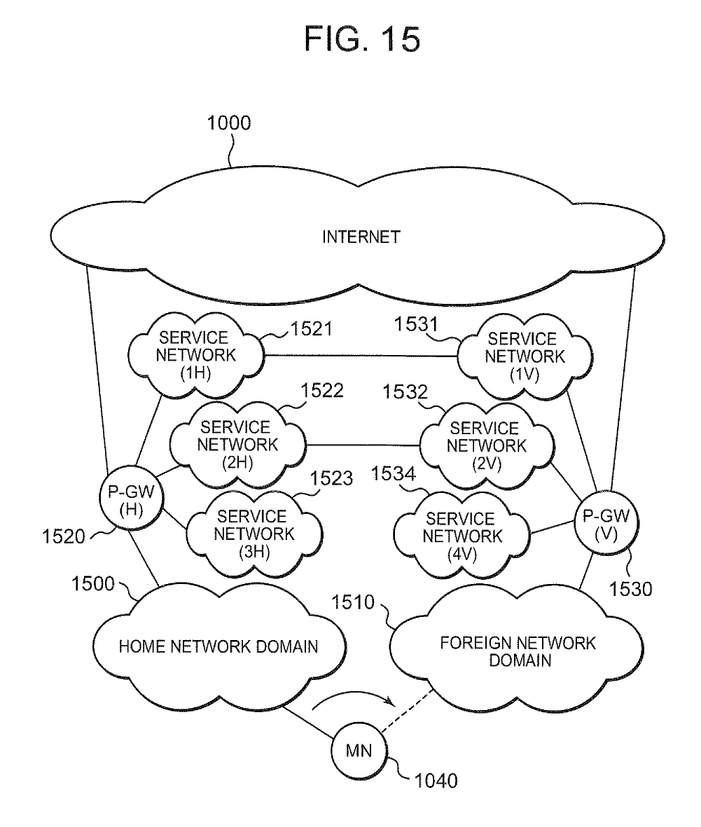

Even in such an environment that combines the above-mentioned circumstances, since prefix registration can be considered, the verification method of the present invention can be employed. As an example of such a case, FIG. 15 shows the application of the present invention when the MN 1040 performs handover in a cellular network. In FIG. 15, a case where the MN 1040 performs handover from a home network domain 1500 to a foreign network domain 1510 is shown as an example, but the present invention is also applicable to a case where the direction of handover is opposite or the case of handover between foreign network domains.

The home network domain 1500 has service networks for providing different services, respectively (shown here are a service network (1H) 1521, a service network (2H) 1522, and a service network (3H) 1523). The foreign network domain 1510 has service networks for providing different services, respectively (shown here are a service network (1V) 1531, a service network (2V) 1532, and a service network (4V) 1534). The home network domain 1500 and the foreign network domain 1510 are connected by the Internet 1000 so that communication can be carried out between the networks through the Internet 1000.

The MN 1040 can connect to either of the two different local mobility management domains (the home network domain 1500 and the foreign network domain 1510). It is assumed here that the MN 1040 first connects to the home network domain 1500, and performs handover to change the connection to the foreign network domain 1510.

It is further assumed that the MN 1040 is assigned plural network prefixes from an entity (e.g., P-GW(H) 1520 here) corresponding to an LMA in the network in the state of the initial connection to the home network domain 1500 to use these prefixes depending on the intended use. As such a case, for example, there is a case where the MN 1040 uses a different prefix (prefix P1h, P2h, or P3h) for each service network connected through the P-GW(H) 1520 in the home network domain 1500 or for its service so that the state can be changed individually at any time.

Here, it is assumed that the MN 1040 performs handover from the home network domain 1500 to the foreign network domain 1510. In the foreign network domain 1510, the MN 1040 is assigned plural network prefixes (prefix P1v, P2v, and P4v) from a P-GW(V) 1530 as a loaming destination depending on the intended use (e.g., for each service). At this time, in the normal connection state, the MN 1040 may not be able to connect to a service network in the home network domain 1500 or may be able to connect only via a network outside of each domain. In other words, the MN 1040 cannot receive packets of prefixes P1h, P2h, and P3h, or can receive them only via a tunneling path that passes through a different network (the Internet 1000 in FIG. 15) communicating between respective operators.

Even in such a case, service qualities in respective operators may be similar and hence the respective service networks may be able to connect directly to each other due to an advanced roaming relationship. For example, when connections are made between the service network (1h) and the service network (1v), and between the service network (2h) and the service network (2v), respectively, the direct connections between these service networks are expected to be higher in terms of management of communication quality and security than the case of connections through a network (e.g., the Internet 1000) outside of the operators. In such a case, if prefix Ply for prefix P1h and prefix P2v for prefix P2h are registered as respective care-of prefixes, packets of these service networks can be handled in association with each other. Further, based on other associations, prefix P3h and prefix P4v can be associated, for example.

Even in the registration of association between network prefixes as mentioned above, the validity of care-of prefixes (here, as to whether the prefix assigned by the P-GW(V) 1530 is registered with the P-GW(H) 1520) needs checking, so that the present invention can be applied in such a manner that the P-GW(V) 1530 corresponds to the LMA and the P-GW(H) 1520 corresponds to the HA.

While the present invention has been described based on the simple network configuration as shown, a wide variety of structures for the local network domain can be considered, including roaming relationships between plural operators. For example, there can be considered a structure using an MAG as a direct access router for a mobile node, and a structure in which the MAG is a boundary router for a different access network (including loaming) so that after once connecting to the different access network, the mobile node will connect to the MAG as the boundary router through the access network. However, even in either structure or condition, it is to be appreciated that the operation of the present invention is applicable in the same manner, though design such as various parameters, a procedure for arriving at MAG from terminal, a communication procedure, etc. are different.

Each of the functional blocks used in describing the aforementioned embodiment of the present invention is implemented as an LSI (Large Scale Integration) typified by an integrated circuit. These may be made up of one chip individually, or they may be made up of one chip to include some or all of them. Here, although the LSI is assumed, it may be called an IC (Integrated Circuit), a system LSI, a super LSI, or an ultra LSI depending on the degree of integration.

Further, the technique for creation of an integrated circuit is not limited to LSI, and it may be implemented by a private circuit or a general-purpose processor. An FPGA (Field Programmable Gate Array) capable of programming after LSI manufacturing or a reconfigurable processor capable of reconfiguring connections or settings of circuit cells within the LSI may also be employed.

In addition, if integrated circuit technology capable of replacing LSI emerges with development of semiconductor technology or another technology derived therefrom, the technology may of course be used to integrate the functional blocks. For example, applications of biotechnology may be possible.

### INDUSTRIAL APPLICABILITY

The present invention has the advantage of preventing the registration of false information that a communication device owning network prefix information is managing prefix information that is not actually managed, and it is applicable to a technique related to a binding update for registering information on a mobile router with another node, a technique associated with the assignment of a network prefix to a mobile terminal that connects to a network-based local mobility management domain and the verification thereof, and a security-related technique that ensures that a packet is sent accurately to a desired partner.

1. A prefix information check device comprising:
packet specifying means for specifying a packet to be transmitted between a communication device assigned network prefix information and a correspondent node communicating with the communication device or a node connected to a network specified in the network prefix information; and
prefix information determining means for referring to the packet specified by the packet specifying means to determine whether a valid value is used for the network prefix information assigned to the communication device.

2. The prefix information check device according to claim 1 further comprising packet discarding means for discarding the packet specified by the packet specifying means as a determination target when the prefix information checking means determines that an invalid value is used for the network prefix information assigned to the communication device.

3. The prefix information check device according to claim 2 further comprising packet discard notifying means which, when the packet as the determination target has been discarded by the packet discarding means as a result of the determination that an invalid value is used for the network prefix information assigned to the communication device, notifies the communication device of that fact.

4. The prefix information check device according to claim 1 further comprising determination result notifying means for notifying the correspondent node of a result of determination made by the prefix information determining means.

5. The prefix information check device according to claim 1, wherein the packet specifying means specifies a packet exchanged when the network prefix information is notified from the communication device to the correspondent node.

6. The prefix information check device according to claim 5, wherein the packet specifying means specifies the packet to be sent from the correspondent node to the communication device.

7. The prefix information check device according to claim 6, wherein the prefix information determining means determines whether prefix information included in the packet specified by the packet specifying means is a valid value for the mobile network prefix information assigned to the communication device.

8. The prefix information check device according to claim 7, wherein the packet specifying means extracts the prefix information included in a destination address of the packet, and the prefix information determining means refers to the extracted prefix information to make a determination.

9. The prefix information check device according to claim 7, wherein the valid value for the network prefix information assigned to the communication device is so defined that a last digit is set to one, and the packet specifying means specifies a value of one in the last digit of the prefix information to extract the prefix information.

10. The prefix information check device according to claim 7, wherein the packet specifying means extracts information indicative of a length of the prefix information and included in a destination address of the packet, and extracts the prefix information included in the destination address of the packet based on the length of the prefix information, and the prefix information determining means refers to the extracted prefix information to make a determination.

11. The prefix information check device according to claim 6, wherein the packet specifying means specifies the packet including a specific bit pattern in a destination address of the packet.

12. The prefix information check device according to claim 11 further comprising:
bit pattern setting means for defining the specific bit pattern; and
bit pattern notifying means for notifying the communication device or the correspondent node of the specific bit pattern so that the specific bit pattern will be set in the destination address of the packet.

13. The prefix information check device according to claim 5, wherein the packet specifying means specifies the packet to be sent from the communication device to the correspondent node.

14. The prefix information check device according to claim 13, wherein the prefix information determining means determines whether prefix information included in the packet specified by the packet specifying means is a valid value for the mobile network prefix information assigned to the communication device.

15. The prefix information check device according to claim 1, wherein the communication device is a mobile router having a mobile network, and the network prefix information is a mobile network prefix specifying the mobile network.

16. The prefix information check device according to claim 1, wherein the communication device is a mobile terminal moving in a local mobility management domain for performing mobility support on a network basis, and the network prefix information is a network prefix uniquely assigned to the mobile terminal from the local mobility management domain.

17. The prefix information check device according to claim 16, wherein the local mobility management domain is a foreign domain different from a home domain of the communication device, and the network prefix information is a care-of prefix to be registered in association with a home address of the communication device.

18. The prefix information check device according to claim 16, wherein the local mobility management domain is a foreign domain different from a home domain of the communication device, and the network prefix information is a care-of prefix to be registered in association with a home prefix of the communication device.

19. The prefix information check device according to claim 16, wherein the local mobility management domain is a home domain of the communication device, and the network prefix information is a home prefix assigned from the home domain.

20. The prefix information check device according to claim 16, wherein the local mobility management domain is a home domain of the communication device, and the network prefix information include a first prefix used as a home prefix assigned from the home address and a second prefix used as a care-of prefix to be registered in association with the home prefix.

21. The prefix information check device according to claim 20, wherein the first prefix and the second prefix can be combined into a third prefix, and processing is performed on the third prefix to collectively check whether valid values are used for both the home prefix and the care-of prefix.

22. A communication device comprising:
test message generating means for generating a test message to check whether a valid value is used for network prefix information when receiving a notification of the network prefix information assigned to a communication device from the communication device assigned the network prefix information; and
destination address setting means for generating an address including the notified network prefix information as an address prefix and information indicative of a length of the network prefix information to set the address as a destination address of the test message.

23. A communication device comprising:
test message generating means for generating a test message to check whether a valid value is used for network prefix information when receiving a notification of the network prefix information assigned to a communication device from the communication device assigned the network prefix information; and
destination address setting means for generating an address including the notified network prefix information as an address prefix and a specific bit pattern indicative of the test message to set the address as a destination address of the test message.

24. The communication device according to claim 23 further comprising:
bit pattern receiving means for receiving a notification of the specific bit pattern usable to indicate the test message; and
bit pattern authenticity checking means for checking authenticity of the specific bit pattern received at the bit pattern receiving means.

25. A communication device wherein a valid value for network prefix information assigned to a communication device assigned the network prefix information is so defined that a last digit is set to one, and when a notification of the network prefix information assigned to the communication device is received from the communication device, it is checked that a value in the last digit of the network prefix information is one.

26. A communication device wherein
a valid value for network prefix information assigned to a communication device assigned the network prefix information is so defined that a last digit is set to one, the communication device comprising:
test message generating means for generating a test message to check whether the valid value is used for network prefix information when a notification of the network prefix information assigned to the communication device is received from the communication device; and
destination address setting means for generating an address including the notified network prefix information as an address prefix and with a bit string following the address prefix set all to zero to set the address as a destination address of the test message.

27. A communication device wherein
a valid value for network prefix information assigned to a communication device assigned the network prefix information is so defined that a last digit is set to one, the communication device comprising:
test message generating means for generating a test message to check whether the valid value is used for network prefix information when a notification of the network prefix information assigned to the communication device is received from the communication device; and
destination address setting means for generating an address including the notified network prefix information as an address prefix and with its tail bit set to one and the remaining bit string set all to zero to set the address as a destination address of the test message.
